(19) United States
(12) Patent Application Publication
(10) Pub. No.: US 2016/0313965 A1
(43) Pub. Date: Oct. 27, 2016

(54) INTERACTIVE CONTROL SYSTEM, TOUCH SENSITIVE DISPLAY APPARATUS AND CONTROL METHOD THEREOF

(71) Applicant: EGALAX_EMPIA TECHNOLOGY INC., Taipei City (TW)

(72) Inventors: CHIN-FU CHANG, TAIPEI CITY (TW); SHANG-TAI YEH, TAIPEI CITY (TW); JIA-MING CHEN, TAIPEI CITY (TW); CHIA-LING SUN, TAIPEI CITY (TW)

(21) Appl. No.: 15/135,778

(22) Filed: Apr. 22, 2016

Related U.S. Application Data
(60) Provisional application No. 62/151,621, filed on Apr. 23, 2015.

(30) Foreign Application Priority Data
Dec. 31, 2015 (TW) 104144650

(51) Int. Cl. G06F 3/14; G06F 3/0481; G06F 3/0484; G06F 3/0488; G09G 5/12

(52) U.S. Cl. CPC G06F 3/1423; G06F 3/04883; G09G 5/12; G06F 3/1454; G06F 3/0484; G06F 3/0481; G09G 2370/02

(57) ABSTRACT

This application provides a control method of a touch sensitive display apparatus, including the following steps: connecting to a first host and a second host via a network interface, and receiving a first picture and a second picture transmitted from the first host and the second host, respectively; displaying at least one part of the first picture and the second picture by a touch sensitive display interface, and receiving a touch sensitive control command corresponding to the displayed part of the first picture and the second picture; and in response to the touch sensitive control command received by the touch sensitive display interface, commanding the first host and the second host to perform a first operation and a second operation through the network interface, respectively.

### CROSS REFERENCE TO RELATED APPLICATIONS

This application claims priority to U.S. patent application Ser. No. 62/151,621, filed on Apr. 23, 2015, and Taiwan patent application, No. 104144650, filed on Dec. 31, 2015, the disclosures of which are incorporated herein by reference.

### BACKGROUND OF THE INVENTION

1. Field of the Invention

The present invention relates to an interactive control system, and more particularly, to control multiple hosts by a touch sensitive display interface.

2. Description of the Prior Art

In the prior art, when a host computer wants to operate or control a remote computer, it can operate only one remote computer at a time and cannot operate multiple remote computers simultaneously. In certain situations, however, there is a need to operate multiple remote computers at the same time. For example, during bidding in an auction, an auctioneer needs to see the bids of multiple bidders almost instantaneously, then compares them in order to select the best-condition bidding winner, and then informs the bidding winner or all the bidders of the selection result.

For solving this problem of one host being unable to operate or control multiple remote computers simultaneously, a system utilizing a touch sensitive display interface to control multiple computers is required for a user to control multiple computers with single operation.

### SUMMARY OF THE INVENTION

In one embodiment, the present application provides a touch sensitive display apparatus, including: a network interface configured to connect a first host and a second host and to receive a first picture and a second picture transmitted from the first host and the second host, respectively; a touch sensitive display interface configured to display at least one part of the first picture and the second picture and to receive a touch sensitive control command corresponding to the at least one part of the first picture and the second picture; and a controller configured to command the first host and the second host to perform a first operation and a second operation via the network interface, respectively, according to the touch sensitive control command received by the touch sensitive display interface.

In one embodiment, the present application provides a control method of a touch sensitive display apparatus, including the following steps: connecting to a first host and a second host via a network interface and receiving a first picture and a second picture transmitted from the first host and the second host, respectively; displaying at least one part of the first picture and the second picture by a touch sensitive display interface and receiving a touch sensitive control command corresponding to the at least one part of the first picture and the second picture; and commanding the first host and the second host to perform a first operation and a second operation via the network interface, respectively, according to the touch sensitive control command received by the touch sensitive display interface.

In one embodiment, the present application provides an interactive control system, including: a first host; a second host; and a touch sensitive display apparatus. The touch sensitive display apparatus may include a network interface configured to connect the first host and the second host and to receive a first picture and a second picture transmitted from the first host and the second host, respectively; a touch sensitive display interface configured to display at least one part of the first picture and the second picture and to receive a touch sensitive control command corresponding to the at least one part of the first picture and the second picture; and a controller configured to command the first host and the second host to perform a first operation and a second operation via the network interface, respectively, according to the touch sensitive control command received by the touch sensitive display interface.

One of the features of the present application is to utilize the multi-touch characteristic of the touch sensitive display apparatus to control multiple hosts and/or touch sensitive display apparatuses. This makes single touch sensitive operation be able to control multiple hosts and/or touch sensitive display apparatuses in the same or different command(s) and it is convenient for user to operate.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 depicts a schematic diagram of an interactive control system 100 according to one embodiment of the present invention;

FIG. 2 depicts a schematic diagram of an interactive control system 200 according to one embodiment of the present invention;

FIG. 3 depicts a schematic diagram of an interactive control system 300 according to one embodiment of the present invention;

FIG. 4 depicts a schematic diagram of an interactive control system 400 according to one embodiment of the present invention;

FIG. 5 illustrates an operation for file duplication of the embodiment shown in FIG. 1;

FIG. 6 illustrates an operation for file duplication of the embodiment shown in FIG. 4;

FIG. 7 depicts a schematic diagram of a touch sensitive display apparatus 700 according to one embodiment of the present invention; and

FIG. 8 shows a flow chart of a method for controlling a touch sensitive display apparatus in accordance with one embodiment of the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

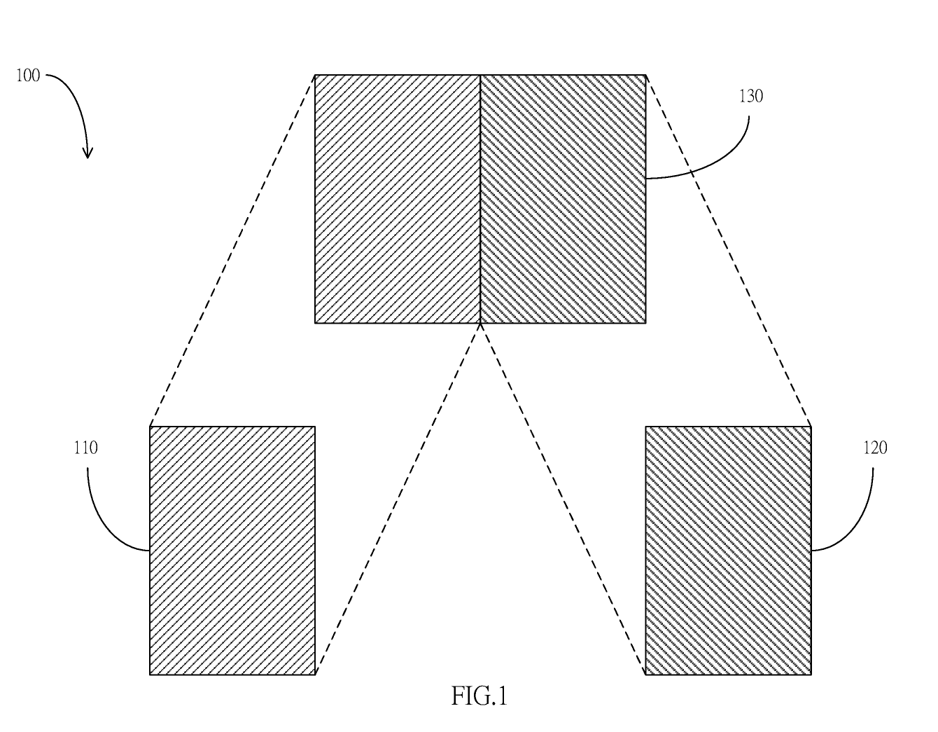

Referring to FIG. 1, an interactive control system 100 according to an embodiment of the present invention is illustrated. In this embodiment, the interactive control system 100 includes a first host 110, a second host 120, and a touch sensitive display apparatus 130. The first host 110 can transmit the contents displayed on its display screen to the touch sensitive display apparatus 130 through the wireline and/or wireless network connection(s). In reality, the first host 110 may include a portable or mobile electronic device, for example, such as a cell phone, a tablet computer, a notebook computer, etc. Similarly, the second host 120 can transmit the contents displayed on its display screen to the touch sensitive display apparatus 130 through the wireline and/or wireless network connection(s). In reality, the second host 120 may include a portable or mobile electronic device, for example, such as a cell phone, a tablet computer, a notebook computer, etc. This invention is not limited to how to transmit the contents displayed on the display screen to the touch sensitive display apparatus 130, and the techniques during transmitting the contents in the prior art, such as coding, encryption, and compression, may be performed. And the techniques during receiving the contents in the prior art, such as decoding, decryption, and decompression, may be performed. Moreover, when the resolution of the display window on the touch sensitive display apparatus 130 is different from the screen resolution of the host 110 or 120, during displaying the contents on the touch sensitive display apparatus 130, proportional or non-proportional scaling of the display contents, and operations such as turning over and rotating of the display contents may be performed.

As shown in FIG. 1, the display screen of the touch sensitive display apparatus 130 is divided into a left portion and a right portion, or contains two windows, wherein the left window displays the contents displayed on the display screen of the first host 110, and the right window displays the contents displayed on the display screen of the second host 120. One of the features of this invention is the touch sensitive display apparatus 130 can simultaneously display the contents transmitted from multiple hosts, but this invention is not limited to the touch sensitive display apparatus 130 displaying the complete contents from each host. Since the touch sensitive display apparatus 130 in this invention can simultaneously display the contents transmitted from multiple hosts, a user of the touch sensitive display apparatus 130 can simultaneously give instructions through an input interface to the displayed contents from different hosts.

In one embodiment, the touch sensitive display apparatus 130 includes a touch interface supporting the function of multi-touch, such as a touch panel. Therefore, a user can contemporaneously give instructions through the touch interface to the display windows. For example, a user can use a first stylus or a first finger to touch the left window, while using a second stylus or a second finger to touch the right window, to achieve the ability to give instructions to the display windows at the same time. In addition, multi-touching can be contemporaneously and respectively performed on the left and right windows, to give instructions by two gestures to the display windows.

In an embodiment of the present invention, the abovementioned instructions each includes at least one coordinate, which is relative to an origin of the display scope of a window. When the touch sensitive display apparatus 130 receives an instruction, the touch sensitive display apparatus 130 may perform a transmission or communication with a corresponding host, according to the instruction and coordinates contained in the instruction. When the resolution of the display window on the touch sensitive display apparatus 130 is different from the screen resolution of a host, proportional or non-proportional scaling of the display contents can be performed upon the coordinates being transmitted. For performing the operations such as turning over and rotating of the display contents, calculations corresponding to these operations need to be performed upon relevant coordinates being transmitted. The above-described calculations related to coordinates may be performed on the part of the hosts, on the part of the touch sensitive display apparatuses, or on both the hosts and the touch sensitive display apparatuses.

In the above-described embodiments, instructions transmitted from the touch sensitive display apparatus to the host may include an instruction input by other types of input interfaces. For example, the instruction may be given by a mouse or by speech recognition. This invention is not limited to the coordinates in instructions being generated by a touch sensitive interface.

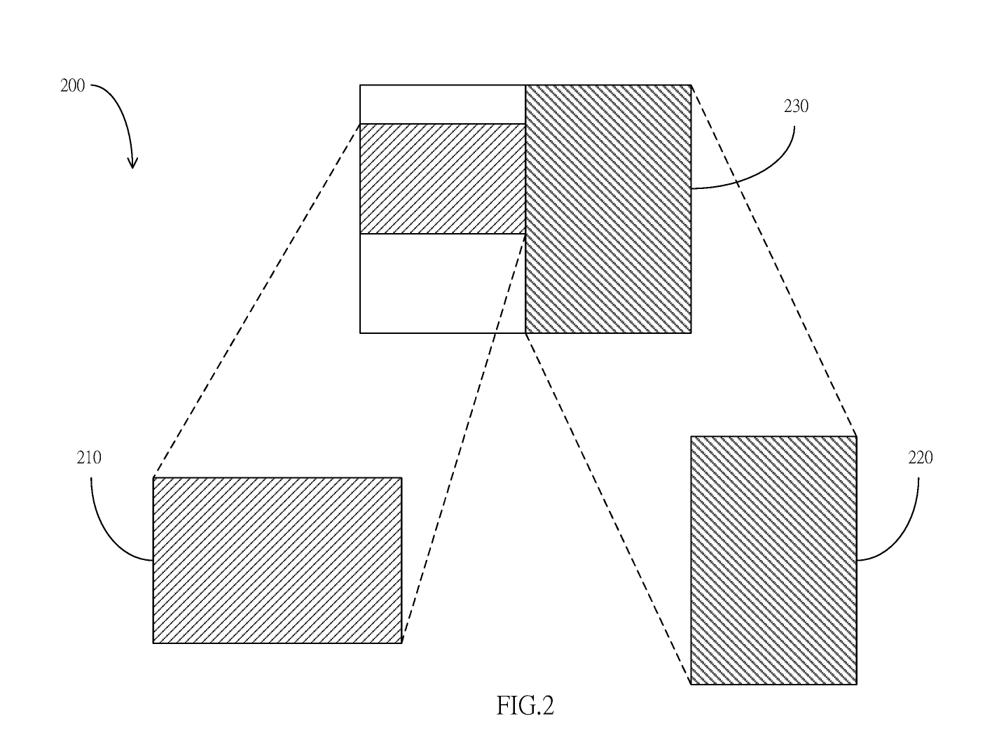

Referring to FIG. 2, an interactive control system 200 according to an embodiment of the present invention is illustrated. Similar to the embodiment shown in FIG. 1, the interactive control system 200 in FIG. 2 includes a first host 210, a second host 220, and a touch sensitive display apparatus 230. The difference between FIG. 2 and FIG. 1 is that the display contents from the first host 210 has been proportionally scaled down and then displayed on the left window of the touch sensitive display apparatus 230. The size and aspect ratio of each of the left and right windows displayed on the touch sensitive display apparatus 230 are different between the two windows. This invention is not limited to all of the hosts having the same display characteristics, and the aspect ratio and/or resolution of the first host 210 can be different from that of the second host 220.

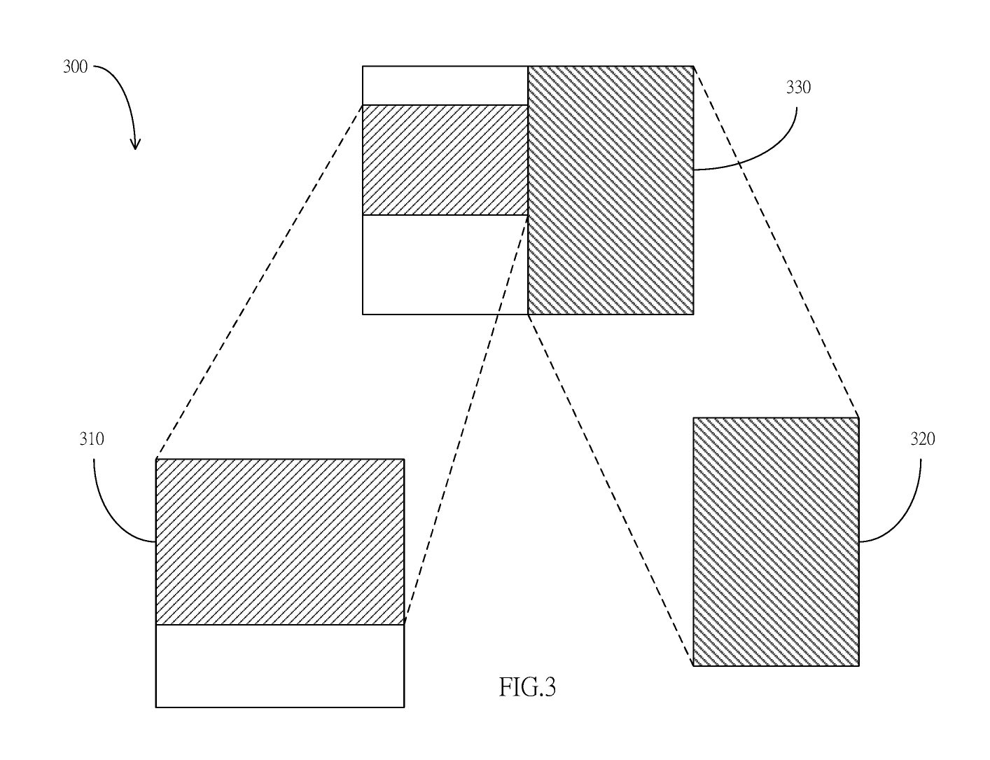

Referring to FIG. 3, an interactive control system 300 according to an embodiment of the present invention is illustrated. Similar to the embodiment shown in FIG. 1, the interactive control system 300 in FIG. 3 includes a first host 310, a second host 320, and a touch sensitive display apparatus 330. The difference between FIG. 2 and FIG. 3 is that some but not all of the display contents from the first host 310 has been proportionally scaled down and then displayed on the left window of the touch sensitive display apparatus 330. The size and aspect ratio of each of the left and right windows displayed on the touch sensitive display apparatus 330 are different between the two windows. This invention is not limited to each host transmitting the whole display contents on its display screen to the touch sensitive display apparatus, and the host can transmit only partial display contents on its display screen to the touch sensitive display apparatus.

In this embodiment, instructions given by the touch sensitive display apparatus 330 to its left window contain coordinates corresponding to the display contents output from the first host 310, but other instructions given by the touch sensitive display apparatus 330 may apply to the whole system of the first host 310.

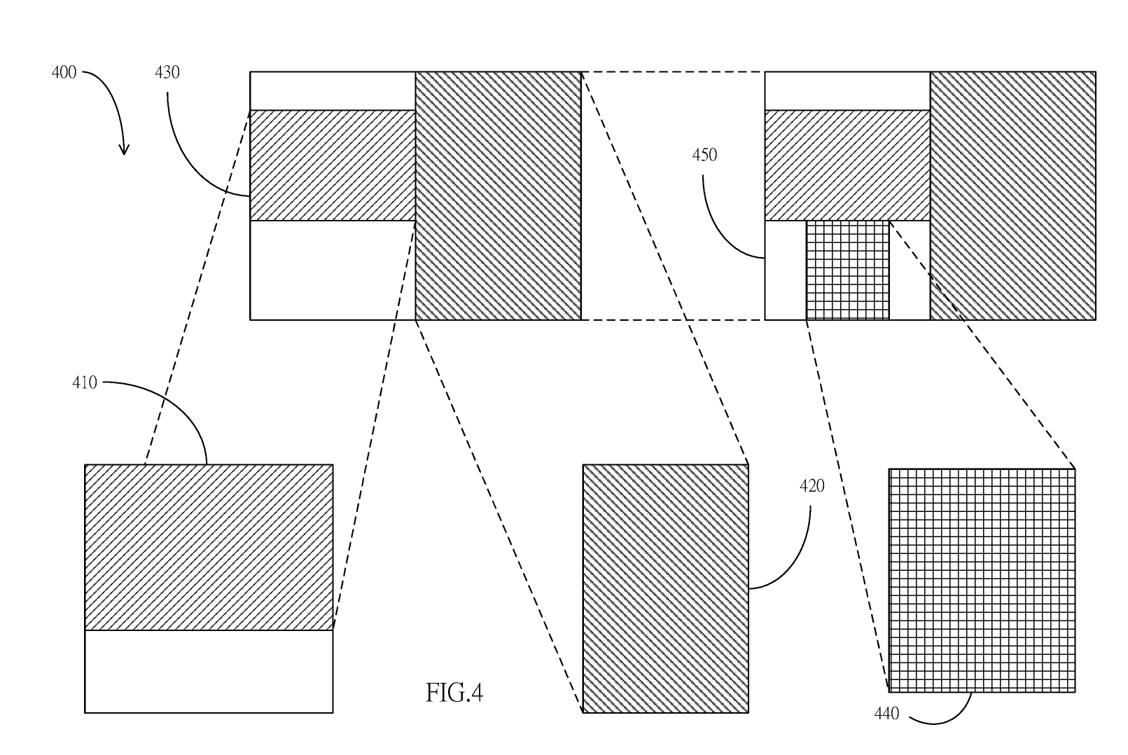

Referring to FIG. 4, an interactive control system 400 according to an embodiment of the present invention is illustrated. The interactive control system 400 includes two touch sensitive display apparatuses, a first touch sensitive display apparatus 430 and a second touch sensitive display apparatus 450, respectively. The interactive control system 400 further includes three hosts, a first host 410, a second host 420, and a third host 440, respectively. Similar to the embodiment shown in FIG. 3, the first touch sensitive display apparatus 430 is responsible for controlling the first host 410 and the second host 420. But different from the embodiments shown in FIGS. 1-3, in addition to controlling the third host 440, the second touch sensitive display apparatus 450 also controls the first touch sensitive display apparatus 430.

As shown in FIG. 4, the display contents output from the first touch sensitive display apparatus 430 to the second touch sensitive display apparatus 450 may include only the display contents from the first host 410 and the second host 420. Hence, the second touch sensitive display apparatus 450 can fit the display contents from the third host 440 onto other space of the second touch sensitive display apparatus 450's display screen. In this embodiment, instructions given by the second touch sensitive display apparatus 450 with respect to the display contents output from the first touch sensitive display apparatus 430 will be respectively forwarded to the first host 410 and the second host 420 through the first touch sensitive display apparatus 430.

In another embodiment, the first touch sensitive display apparatus 430 may output its whole display contents to the second touch sensitive display apparatus 450. That is, the first touch sensitive display apparatus 430's whole display contents include its own display contents, in addition to the display contents from the first host 410 and the second host 420, which two hosts are controlled by the first touch sensitive display apparatus 430. In this embodiment, instructions given by the second touch sensitive display apparatus 450 with respect to the display contents output from the first touch sensitive display apparatus 430 and originally from the first host 410 and the second host 420 will be respectively forwarded to the first host 410 and the second host 420 through the first touch sensitive display apparatus 430. And instructions given by the second touch sensitive display apparatus 450 with respect to the display contents of the first touch sensitive display apparatus 430's own will be handled by the first touch sensitive display apparatus 430 itself.

According to the embodiments of FIG. 4, one of the features of this invention is that a touch sensitive display apparatus can act as a host for another touch sensitive display apparatus. The host may be responsible for forwarding display contents, and may forward instructions it has received. When outputting its own display contents, the host is responsible for handling instructions corresponding to its own display contents.

A control system with the above-described characteristics can be applied to a hierarchical commanding system. For example, a weapons officer in a battleship may be responsible for monitoring devices respectively in a missile commander's and an arms commander's charge. But, apart from monitoring devices in a weapons officer's charge, the captain of the battleship may also be responsible for monitoring devices in an engineer officer's charge.

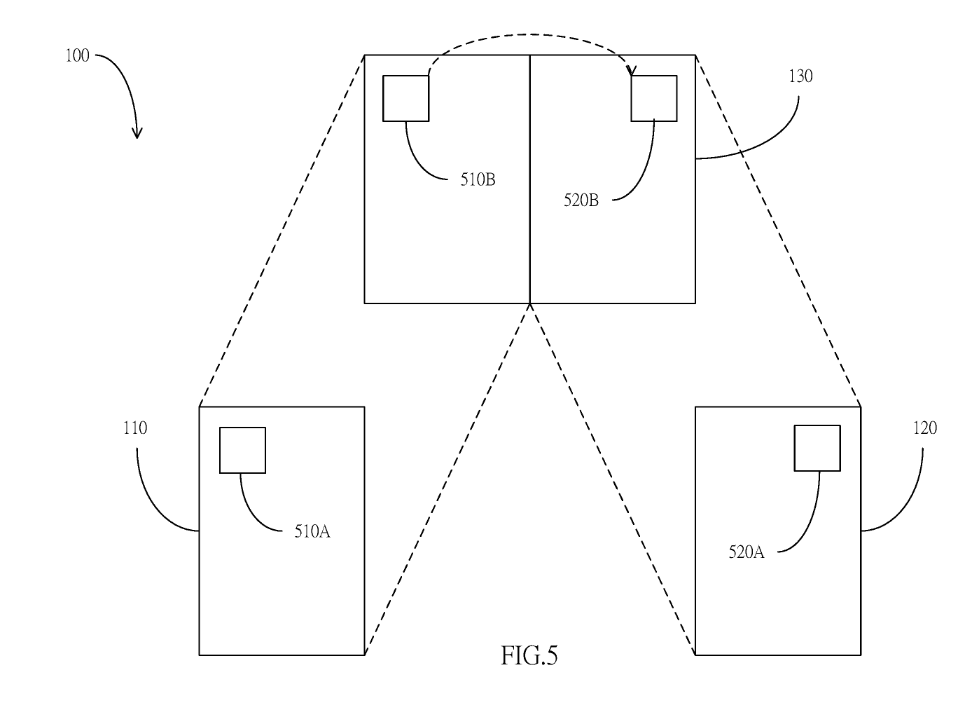

Referring to FIG. 5, an operation for file duplication of the embodiment shown in FIG. 1 is illustrated. In FIG. 5, the display screen of the first host 110 has an icon 510A corresponding to an information set, such as file(s), directory (directories), hyperlink(s), remote source link(s), etc. In some embodiments, the icon may not correspond to any information set but only information itself. The left window of the touch sensitive display apparatus 130 still has an icon 510B corresponding to the icon 510A.

The user of the touch sensitive display apparatus 130 may drag the icon 510B to the right window, that is, to duplicate or move the information set in response to the icon 510A to the second host 120. In some embodiments, the touch sensitive display apparatus 130 may inform the second host 120 of the drop position of new icon 520B, and commands the first host 110 and the second host 120 to build up a network connection to perform certain a transmission protocol, such as ftp, http, samba, NetBEUI, NetBIOS, etc. The icon 510A and the information set in response to the icon 510A are duplicated or moved to the second host 120 through the transmission protocol. After saving the icon 510A and the information set in response to the icon 510A to the suitable position(s), the second host 120 displays the icon 520A at an assigned drop position on its display screen and builds up the corresponding relation between the icon 520A and the duplicated information set. Finally, the second host 120 transmits the contents of its display screen to the touch sensitive display apparatus 130, and the user of the touch sensitive display apparatus 130 is able to see the new duplicated icon 520B. When the abovementioned drag instruction is the move instruction, after duplication, the touch sensitive display apparatus 130 needs to command the first host 110 to delete the icon 510A and the information set corresponding to the icon 510A.

In some embodiments, the touch sensitive display apparatus 130 may inform the second host 120 of the drop position of the new icon 520B, and commands the first host 110 to transmit the icon 510A and the information set in response to the icon 510A to the touch sensitive display apparatus 130, and then transmits the received icon and information set to the second host 120. After saving the icon 510A and the information set in response to the icon 510A to the suitable position(s), the second host 120 displays the icon 520A at an assigned drop position on its display screen and builds up the corresponding relation between the icon 520A and the duplicated information set. Finally, the second host 120 transmits the contents of its display screen to the touch sensitive display apparatus 130, and the user of the touch sensitive display apparatus 130 is able to see the new duplicated icon 520B. When the abovementioned drag instruction is the move instruction, after duplication, the touch sensitive display apparatus 130 needs to command the first host 110 to delete the icon 510A and the information set corresponding to the icon 510A.

In the abovementioned embodiments, the touch sensitive display apparatus 130 may do certain a transmission protocol, such as ftp, http, samba, NetBEUI, NetBIOS, etc., to individually perform the transmission operation to the first host 110 and the second host 120. This invention is not limited to the touch sensitive display apparatus 130 performing the same transmission protocol to the first host 110 and the second host 120. Also, this invention is not limited to the touch sensitive display apparatus 130 starting to transmit the information to the second host 120, which is transmitted from the first host 110, after the information transmitted from the first host 110 being completely received by the touch sensitive display apparatus 130. For example, after receiving a part of information transmitted from the first host 110, the touch sensitive display apparatus 130 may directly forward this information to the second host 120. In addition, since the resolution and the display setting might be different, the size, color and resolution of the icons 510B and 520B displayed on the touch sensitive display apparatus 130 might be different either.

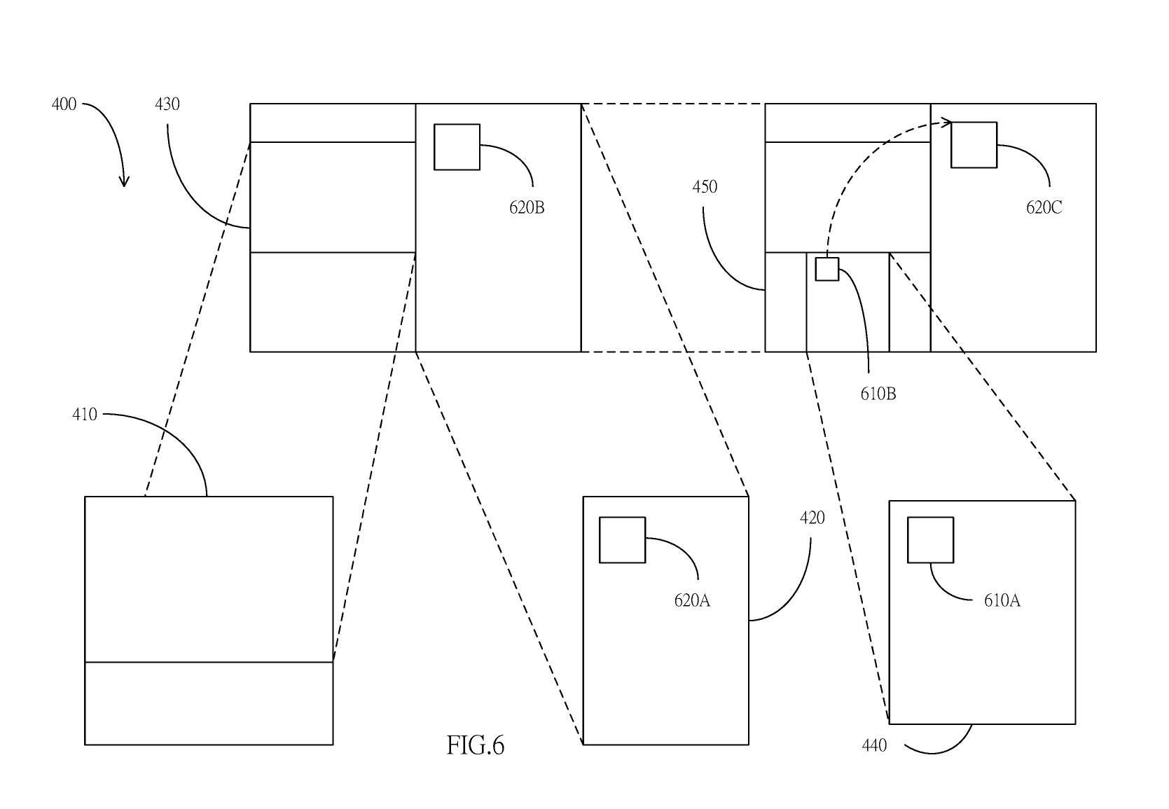

Referring to FIG. 6, an operation for file duplication of the embodiment shown in FIG. 4 is illustrated. In FIG. 6, the display screen of the third host 440 has an icon 610A corresponding to an information set, such as file(s), directory (directories), hyperlink(s), remote source link(s), etc. In some embodiments, the icon may not correspond to any information set but only information itself. The down-left window of the touch sensitive display apparatus 450 still has an icon 610B corresponding to the icon 610A.

The user of the second touch sensitive display apparatus 450 may drag the icon 610B to the right window. However, the second touch sensitive display apparatus 450 does not clearly know the drag and drop position of the icon 610B being in response to the first touch sensitive display apparatus 430 or the host connected by the first touch sensitive display apparatus 430. Hence, in some embodiments, the second touch sensitive display apparatus 450 may inform the first touch sensitive display apparatus 430 of the abovementioned drag and drop position. After correspondingly transferring, the first touch sensitive display apparatus 430 reports the position corresponding to the second host 420.

In some embodiments, the first touch sensitive display apparatus 430 may inform the second host 420 of the drop position of new icon 620C. The second touch sensitive display apparatus 450 and the first touch sensitive display apparatus 430 may individually command the third host 440 and the second host 420 to build up a network connection to perform certain a transmission protocol, such as ftp, http, samba, NetBEUI, NetBIOS, etc. The icon 610A and the information set in response to the icon 610A are duplicated or moved to the second host 420 through the transmission protocol. After saving the icon 610A and the information set in response to the icon 610A to the suitable position(s), the second host 420 displays the icon 620A at an assigned drop position on its display screen and builds up the corresponding relation between the icon 620A and the duplicated information set. The second host 420 transmits the contents of its display screen to the first touch sensitive display apparatus 430, and the user of the first touch sensitive display apparatus 430 is able to see the new duplicated icon 620B. The first touch sensitive display apparatus 430 further transmits the contents of its display screen to the second touch sensitive display apparatus 450, and the user of the second touch sensitive display apparatus 450 is able to see the new duplicated icon 620C. When the abovementioned drag instruction is the move instruction, after duplication, the second touch sensitive display apparatus 450 needs to command the third host 440 to delete the icon 610A and the information set corresponding to the icon 610A.

In some embodiments, the second touch sensitive display apparatus 450 may command the third host 440 to transmit the icon 610A and the information set corresponding to the icon 610A to the second touch sensitive display apparatus 450. And then, the second touch sensitive display apparatus 450 transmits the received icon and information set to the first touch sensitive display apparatus 430. The first touch sensitive display apparatus 430 may transmit the icon and information set to the second host 420, which are received from the second touch sensitive display apparatus 450. After saving the icon 610A and the information set in response to the icon 610A to the suitable position(s), the second host 420 displays the icon 620A at an assigned drop position on its display screen and builds up the corresponding relation between the icon 620A and the duplicated information set. The second host 420 transmits the contents of its display screen to the first touch sensitive display apparatus 430, and the user of the first touch sensitive display apparatus 430 is able to see the new duplicated icon 620B. The first touch sensitive display apparatus 430 further transmits the contents of its display screen to the second touch sensitive display apparatus 450, and the user of the second touch sensitive display apparatus 450 is able to see the new duplicated icon 620C. When the abovementioned drag instruction is the move instruction, after duplication, the second touch sensitive display apparatus 450 needs to command the third host 440 to delete the icon 610A and the information set corresponding to the icon 610A.

In the abovementioned embodiments, the second touch sensitive display apparatus 450 may do certain a transmission protocol, such as ftp, http, samba, NetBEUI, NetBIOS, etc., to individually perform the transmission operation to the third host 440 and the first touch sensitive display apparatus 430. Also, the first touch sensitive display apparatus 430 may do certain a transmission protocol, such as ftp, http, samba, NetBEUI, NetBIOS, etc., to individually perform the transmission operation to the second host 420 and the second touch sensitive display apparatus 450. This invention is not limited to the first touch sensitive display apparatus 430 and the second touch sensitive display apparatus 450 performing the same transmission protocol to the second host 420 and the third host 440.

This invention is not limited to the second touch sensitive display apparatus 450 starting to transmit the information to the first touch sensitive display apparatus 430, which is transmitted from the third host 440, after the information transmitted from the third host 440 being fully received by the second touch sensitive display apparatus 450. For example, after receiving a part of information transmitted from the third host 440, the second touch sensitive display apparatus 450 may directly forward this information to the first touch sensitive display apparatus 430. Also, this invention is not limited to the first touch sensitive display apparatus 430 starting to transmit the information to the second host 420, which is transmitted from the second touch sensitive display apparatus 450, after the information transmitted from the second touch sensitive display apparatus 450 being fully received by the first touch sensitive display apparatus 430. For example, after receiving a part of information transmitted from the second touch sensitive display apparatus 450, the first touch sensitive display apparatus 430 may directly forward this information to the second host 420. In addition, since the resolution and the display setting might be different, the size, color and resolution of the icons 610B and 620C displayed on the second touch sensitive display apparatus 450 might be different either.

In the above embodiments, the user drags and drops the icon(s) to a space area. In some embodiments, however, the user may drag and drop an icon to another icon or a block having a particular meaning. For example, when the user drags an icon to certain a directory icon, it means that the user assigns the information set related to the icon to be saved in the directory related to the directory icon. In one exemplary, when the user drags an icon to a printer icon, it means that the user assigns the information set related to the icon to be printed out by the printer related to the printer icon. In another exemplary, when the user drags an icon to certain a playlist block, it means that the user assigns the information set related to the icon to be played sequentially by certain a media player. The above-described correlation operation may be performed after duplication or moving, or during duplication or moving.

From the embodiments shown in FIG. 5 and FIG. 6, a result can be derived. For example, in the present application, when the user of the touch sensitive display apparatus performs a drag operation to drag and drop the object(s) between/among two or two above host's screens, the information transmission can directly be performed between/among the hosts or can be transmitted via the touch sensitive display apparatus. When there is a multi-layered touch sensitive display apparatus, these two manners also can be applied to perform the information transmission between/among the hosts. One ordinary skilled in the art can appreciate, in addition to the information transmission between host and host, these two manners, similarly, can be applied to perform the information transmission between the host and the touch sensitive display apparatus. In certain complicated situations, these two manners may be performed simultaneously. For example, in the embodiment of FIG. 6, a direct connection between the third host 440 and the first touch sensitive display apparatus 430 may be built up, and hence forwarding by the second touch sensitive display apparatus 450 is unnecessary anymore. And then, through the connection between the first touch sensitive display apparatus 430 and the second host 420, the second host 420 and the third host 440 can perform the information transmission operation through only the first touch sensitive display apparatus 430.

Further, the abovementioned embodiments all perform information transmission between the hosts. However, in some embodiments, the host's icon and the information corresponding to the icon may be duplicated or moved to the touch sensitive display apparatus, and vice versa. For example, in certain an embodiment of FIG. 6, when the user of the second touch sensitive display apparatus 450 drags the icon 610B to the screen block occupied by neither the first touch sensitive display apparatus 430 nor the third host 440, it means the user wants to drag the icon 610B to the second touch sensitive display apparatus 450. On the contrary, when the user of the second touch sensitive display apparatus 450 drags the local icon to the screen block occupied by the third host 440 or the first touch sensitive display apparatus 430, it means the user wants to duplicate or move the icon of the second touch sensitive display apparatus 450 and the information corresponding to the icon to the third host 440 or the host connected by the first touch sensitive display apparatus 430.

In certain an embodiment of FIG. 6, when the user of the second touch sensitive display apparatus 450 simultaneously drags three icons individually from the first host 410, the second host 420, and the third host 440 to the desktop of the second touch sensitive display apparatus 450, it means the user wants to combine the information sets individually corresponding to the three icons and to give them a new icon for representing. In some embodiments, when the user of the second touch sensitive display apparatus 450 drags certain a graphic file, certain a camera icon, or certain mic icon to the desktop block or certain icons in response to the first host 410, the second host 420, and the third host 440 at the same time, it means the user wants the hosts 410-430 to show or play the graphic file, the video picture, or the voice in union.

In above-described embodiments, just using a mouse to control a cursor is unable to achieve those tasks, and those tasks can be implemented by a multi-touch interface. In other words, one of the features of the present application is to utilize the characteristic of multi-touch of the touch sensitive display apparatus to control multiple hosts and/or touch sensitive display apparatuses. Accordingly, single touch sensitive operation can give multiple hosts and/or touch sensitive display apparatuses the same or different instruction(s) for the user(s) to operate conveniently.

In the present application, the host and the touch sensitive display apparatus may use multiple transmission protocols. For example, a real-time transmission protocol is used to transmit the host's picture to the touch sensitive display apparatus, and another non-real-time transmission protocol is used to transmit the information in response to the picture at the same time. Or, a transmission protocol being suitable to have a fixed transmission rate is used to transmit the picture, and another transmission protocol being suitable to have a variable transmission rate is used to transmit the information. Or, a transmission protocol permitting of missing information is used to transmit the picture, and another transmission protocol prohibiting from missing information is used to transmit the information. Or, a transmission protocol with service guarantee is used to transmit the picture, and another transmission protocol without service guarantee is used to transmit the information. In other words, the packages used to transmit the picture have higher priority, and the packages used to transmit the information have lower priority. Or, a compressing, a coding, and other common protocols may be applied to. In some embodiments, only one transmission protocol may be used to transmit the picture and the information. This application is not limited to use what kind of network communication techniques and transmission protocols and how to transmit the picture and information.

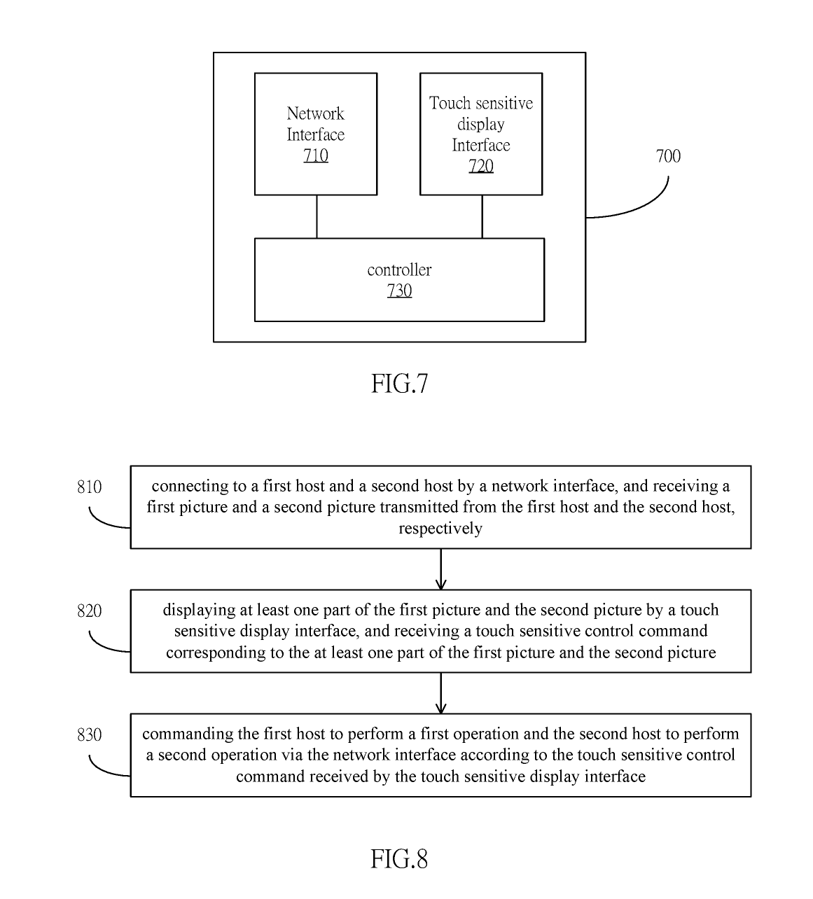

Referring to FIG. 7, a schematic diagram of a touch sensitive display apparatus 700 according to one embodiment of the present invention is illustrated. The touch sensitive display apparatus 700 may be the touch sensitive display apparatus or host shown in FIGS. 1-6. In other words, the embodiment of FIG. 7 can apply to each touch sensitive display apparatus or host shown in FIGS. 1-6. The touch sensitive display apparatus 700 includes at least one network interface 710, a touch sensitive display interface 720, and a controller 730 connected to the network interface 710 and the touch sensitive display interface 720.

The network interface 710 may include a wireline network interface or a wireless network interface, and is only required for the touch sensitive display apparatus 700 being able to use it to connect the host to receive the pictures and to transmit instructions and information sets. The touch sensitive display interface 720 may include a displayer and a touch sensitive interface on the displayer. For example, it may be a resistive touch screen, self-capacitive touch screen, mutual-capacitive touch screen, optical touch screen, and ultra-sonic touch screen. The touch sensitive display interface 720 may include a graphic display control chip and a touch sensitive chip. The controller 730 may include a central process unit (CPU), and a memory system connected to the CPU. The controller 730 is configured to execute the program instruction(s) of operation(s) in accordance with the present application.

In some embodiments, a touch sensitive display apparatus includes: a network interface configured to connect a first host and a second host and to receive a first picture and a second picture transmitted from the first host and the second host, respectively; a touch sensitive display interface configured to display at least one part of the first picture and the second picture and to receive a touch sensitive control command corresponding to the at least one part of the first picture and the second picture; and a controller configured to command the first host and the second host to perform a first operation and a second operation via the network interface, respectively, according to the touch sensitive control command received by the touch sensitive display interface.

In certain an embodiment, the first host may be a kind of the touch sensitive display apparatus. In a variation of the embodiment, the second host may be the kind of the touch sensitive display apparatus as well. Alternatively, a network interface of the first host is configured to connect a third host and a fourth host and to receive a third picture and a fourth picture transmitted from the third host and the fourth host, respectively, wherein the first picture includes at least one part of the third picture and/or the fourth picture, the network interface of the first host is further configured to receive the command of the first operation; a touch sensitive display interface of the first host is configured to display the at least one part of the third picture and the fourth picture; and a controller of the first host is configured to command the third host to perform a third operation and/or the fourth host to perform a fourth operation according to the command of the first operation.

In a variation of the abovementioned embodiment, the third operation includes outputting an information set to the first host, the first operation includes receiving and outputting the information set to the touch sensitive display apparatus, the second operation includes receiving the information set from the touch sensitive display apparatus. In another variation, the fourth operation includes receiving the information set.

In some embodiments, the network interface receives the first picture and the second picture by a first transmission protocol, the network interface commands the first host to perform the first operation and the second host to perform the second operation by a second transmission protocol, the first transmission protocol, in some cases, may be different to the second transmission protocol. However, the first transmission protocol could also be the second transmission protocol.

In some embodiments, the network interface is further configured to connect a third host and to receive a third picture transmitted from the third host; the touch sensitive display interface is further configured to display at least one part of the third picture; and the controller is further configured to command the third host to perform a third operation via the network interface according to the touch sensitive control command received by the touch sensitive display interface, wherein the first operation includes outputting a first information set, the second operation includes outputting a second information set, the third operation includes receiving the first information set and the second information set and then combining them as a third information set.

Referring to FIG. 8, a flow chart of a method for controlling a touch sensitive display apparatus in accordance with one embodiment of the present invention is shown. The control method can be applied to the controller 730 shown in FIG. 7 to control the touch sensitive display apparatus. One ordinary skilled in the art can appreciate the control method can be implemented by one or any combination of software and hardware. Except for sequence relationship required in each step, this application is not limited to the step being executed in order.

In step 810: connecting to a first host and a second host by a network interface, and receiving a first picture and a second picture transmitted from the first host and the second host, respectively.

In step 820: displaying at least one part of the first picture and the second picture by a touch sensitive display interface, and receiving a touch sensitive control command corresponding to the at least one part of the first picture and the second picture.

In step 830: commanding the first host to perform a first operation and the second host to perform a second operation via the network interface according to the touch sensitive control command received by the touch sensitive display interface.

In certain an embodiment, the first host may be a kind of the touch sensitive display apparatus. In a variation of the embodiment, the second host may also be the kind of the touch sensitive display apparatus. Alternatively, a network interface of the first host is configured to connect a third host and a fourth host and to receive a third picture and a fourth picture transmitted from the third host and the fourth host, respectively, wherein the first picture includes at least one part of the third picture and/or the fourth picture, the network interface of the first host is further configured to receive the command of the first operation; a touch sensitive display interface of the first host is configured to display the at least one part of the third picture and the fourth picture; and a controller of the first host is configured to command the third host to perform a third operation and/or the fourth host to perform a fourth operation according to the command of the first operation.

In some embodiments, the control method may further include: commanding the network interface to receive the first picture and the second picture by a first transmission protocol; and commanding the network interface to command the first host to perform the first operation and the second host to perform the second operation by a second transmission protocol, wherein the first transmission protocol may be different to the second transmission protocol.

In some embodiments, the control method may further include: connecting to a third host by the network interface and receiving a third picture transmitted from the third host; displaying at least one part of the third picture by the touch sensitive display interface; and commanding the third host to perform a third operation via the network interface according to the touch sensitive control command received by the touch sensitive display interface, wherein the first operation includes outputting a first information set, the second operation includes outputting a second information set, the third operation includes receiving the first information set and the second information set and then combining them as a third information set.

The present application provides an interactive control system, including: a first host; a second host; and a touch sensitive display apparatus. The touch sensitive display apparatus may include a network interface configured to connect the first host and the second host and to receive a first picture and a second picture transmitted from the first host and the second host, respectively; a touch sensitive display interface configured to display at least one part of the first picture and the second picture and to receive a touch sensitive control command corresponding to the at least one part of the first picture and the second picture; and a controller configured to command the first host and the second host to perform a first operation and a second operation via the network interface, respectively, according to the touch sensitive control command received by the touch sensitive display interface.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A touch sensitive display apparatus, comprising:
a network interface, configured to connect a first host and a second host and to receive a first picture and a second picture transmitted from the first host and the second host, respectively;
a touch sensitive display interface, configured to display at least one part of the first picture and the second picture and to receive a touch sensitive control command corresponding to the at least one part of the first picture and the second picture; and
a controller, configured to command the first host and the second host to perform a first operation and a second operation via the network interface, respectively, according to the touch sensitive control command received by the touch sensitive display interface.

2. The touch sensitive display apparatus of claim 1, wherein the first host is a kind of the touch sensitive display apparatus.

3. The touch sensitive display apparatus of claim 2, wherein the second host is the kind of the touch sensitive display apparatus.

4. The touch sensitive display apparatus of claim 2, wherein a network interface of the first host is configured to connect a third host and a fourth host and to receive a third picture and a fourth picture transmitted from the third host and the fourth host, respectively, wherein the first picture includes at least one part of the third picture and/or the fourth picture, the network interface of the first host is further configured to receive the command of the first operation; a touch sensitive display interface of the first host is configured to display the at least one part of the third picture and the fourth picture; and a controller of the first host is configured to command the third host to perform a third operation and/or the fourth host to perform a fourth operation according to the command of the first operation.

5. The touch sensitive display apparatus of claim 1, wherein the network interface receives the first picture and the second picture by a first transmission protocol, the network interface commands the first host to perform the first operation and the second host to perform the second operation by a second transmission protocol, wherein the first transmission protocol is different to the second transmission protocol.

6. The touch sensitive display apparatus of claim 4, wherein the third operation includes outputting an information set to the first host, the first operation includes receiving and outputting the information set to the touch sensitive display apparatus, the second operation includes receiving the information set from the touch sensitive display apparatus.

7. The touch sensitive display apparatus of claim 6, wherein the fourth operation includes receiving the information set.

8. The touch sensitive display apparatus of claim 1, wherein the network interface is further configured to connect a third host and to receive a third picture transmitted from the third host; the touch sensitive display interface is further configured to display at least one part of the third picture; and the controller is further configured to command the third host to perform a third operation via the network interface according to the touch sensitive control command received by the touch sensitive display interface, wherein the first operation includes outputting a first information set, the second operation includes outputting a second information set, the third operation includes receiving the first information set and the second information set and then combining them as a third information set.

9. A control method of a touch sensitive display apparatus, comprising:
connecting to a first host and a second host via a network interface and receiving a first picture and a second picture transmitted from the first host and the second host, respectively;
displaying at least one part of the first picture and the second picture by a touch sensitive display interface and receiving a touch sensitive control command corresponding to the at least one part of the first picture and the second picture; and
commanding the first host to perform a first operation and the second host to perform a second operation via the network interface, respectively, according to the touch sensitive control command received by the touch sensitive display interface.

10. The control method of claim 9, wherein the first host is a kind of the touch sensitive display apparatus.

11. The control method of claim 10, wherein a network interface of the first host is configured to connect a third host and a fourth host and to receive a third picture and a fourth picture transmitted from the third host and the fourth host, respectively, wherein the first picture includes at least one part of the third picture and/or the fourth picture, the network interface of the first host is further configured to receive the command of the first operation; a touch sensitive display interface of the first host is configured to display the at least one part of the third picture and the fourth picture; and a controller of the first host is configured to command the third host to perform a third operation and/or the fourth host to perform a fourth operation according to the command of the first operation.

12. The control method of claim 9, further comprising:
commanding the network interface to receive the first picture and the second picture by a first transmission protocol; and
commanding the network interface to command the first host to perform the first operation and the second host to perform the second operation by a second transmission protocol, wherein the first transmission protocol is different to the second transmission protocol.

13. The control method of claim 9, further comprising:
connecting to a third host by the network interface and receiving a third picture transmitted from the third host;
displaying at least one part of the third picture by the touch sensitive display interface; and
commanding the third host to perform a third operation via the network interface according to the touch sensitive control command received by the touch sensitive display interface,
wherein the first operation includes outputting a first information set, the second operation includes outputting a second information set, the third operation includes receiving the first information set and the second information set and then combining them as a third information set.

14. An interactive control system, comprising:
a first host;
a second host; and
a touch sensitive display apparatus, comprising:
a network interface, configured to connect the first host and the second host and to receive a first picture and a second picture transmitted from the first host and the second host, respectively;
a touch sensitive display interface, configured to display at least one part of the first picture and the second picture and to receive a touch sensitive control command corresponding to the at least one part of the first picture and the second picture; and
a controller, configured to command the first host to perform a first operation and the second host to perform a second operation via the network interface according to the touch sensitive control command received by the touch sensitive display interface.
